(19) United States
(12) Patent Application Publication
(10) Pub. No.: US 2023/0396717 A1
(43) Pub. Date: Dec. 7, 2023

(54) DETERMINING CAUSES OF STREAKING

(71) Applicant: Hewlett-Packard Development Company, L.P., Spring, TX (US)

(72) Inventors: Kiyoun LEE, Seongnam-si (KR); Minki CHO, Seongnam-si (KR)

(21) Appl. No.: 18/031,931

(22) PCT Filed: Jan. 29, 2021
(86) PCT No.: PCT/US2021/015638

§ 371 Date: Apr. 14, 2023

(30) Foreign Application Priority Data
Oct. 16, 2020 (KR) 10-2020-0134514

(51) Int. Cl. H04N 1/00

(52) U.S. Cl. CPC H04N 1/00037; H04N 1/00092; H04N 1/00018; H04N 1/00015

(57) ABSTRACT

An example image forming apparatus includes an image forming unit to form an image on a print medium, a verification scanning unit to scan a first surface of the print medium on which an image has been formed and to scan a second surface on which no image has been formed, and a processor to determine, based on information on a position of a streak included in a scanned image of the first surface or the second surface, whether the streak has been caused by an image forming unit or the verification scanning unit.

### BACKGROUND

There exist different types of image forming apparatuses, including printers, scanners, photocopiers, facsimile machines, etc., as well as multi-function products (MFPs) that may provide a combination of functions, e.g., print, copy, scan, and fax functions.

Various management techniques are applied to these image forming apparatuses. Examples of the above-described management techniques include a technique for monitoring the quality of a printed material output by an image forming apparatus and, when there is a problem, notifying a manager of the apparatus of the problem.

### BRIEF DESCRIPTION OF THE DRAWINGS

FIG. 1 is a block diagram illustrating an image forming apparatus according to an example;

FIG. 2 is a diagram showing a candidate for an arrangement position of a verification scanning unit in an image forming apparatus according to an example:

FIG. 3 is a diagram illustrating components of an image forming apparatus employing a verification scanning unit according to an example;

FIG. 4 is a diagram illustrating components of an image forming apparatus employing a verification scanning unit according to an example;

FIGS. 5A and 5B are flowcharts of a procedure for determining a cause of streaking in an image forming apparatus according to an example;

FIG. 6 is a diagram illustrating components of an image forming apparatus employing a verification scanning unit according to an example;

FIG. 7 is a diagram illustrating components of an image forming apparatus employing a verification scanning unit according to an example;

FIGS. 8A and 8B are flowcharts of a procedure for determining a cause of streaking in an image forming apparatus according to an example;

FIG. 9 is a flowchart of a procedure of an image forming method according to an example: and

FIG. 10 illustrates a computer-readable recording medium according to an example.

### DETAILED DESCRIPTION

Various terms used in the following examples are chosen from a terminology of commonly used terms in consideration of their function herein, which may be appreciated differently depending on an intention of a person skilled in the art, a precedent case, or an emerging new technology. In some cases, terms may be construed as set forth in the following examples. Accordingly, the terms used herein are to be defined consistently with their meanings in the context of the various examples, rather than simply by their plain and ordinary meaning.

The terms “comprising,” “including,” “having,” “containing,” etc. are used herein when specifying the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, the ordinal terms are not to limit the scope of the present disclosure. Also, the use of the term “and/or” in a list of multiple elements is inclusive of all possible combinations of the listed items, including any one or plurality of the items.

The term “image forming job” as used herein may encompass any of a variety of image-related jobs, such as a print job, a scan job, a photocopy job, a facsimile transmission job, and the like, that involve an operation of forming an image and/or other processing operation, e.g., creation, generation and/or transfer of an image file. Furthermore, an image forming job performed by an image forming apparatus may comprise various jobs related to printing, photocopying, scanning, faxing, storing, transmitting, coating, etc.

The term “image forming apparatus” as used herein may encompass any of a variety of apparatuses, such as a printer, a scanner, a photocopier, a facsimile machine, a multi-function product (MFPs), and so on, that carries out an image forming job. Moreover, an image forming apparatus may be a two-dimensional (2D) or three-dimensional (3D) image forming apparatus.

The term “user” as used herein may refer to a person who manipulates an image forming apparatus to operate an image forming job. Further, the term “administrator” as used herein may refer to a person who has access to the entire functionality of an image forming apparatus. In some examples, one person may have both the roles of an administrator and a user.

Certain examples of the present disclosure will now be described with reference to the accompanying drawings. The various examples may, however, be implemented in many different forms and should not be construed as limited to the examples set forth herein. Rather, these examples are given in order to provide a better understanding of the scope of the present disclosure.

Hereinafter, examples of the above-described image forming apparatus will be described with reference to the accompanying drawings.

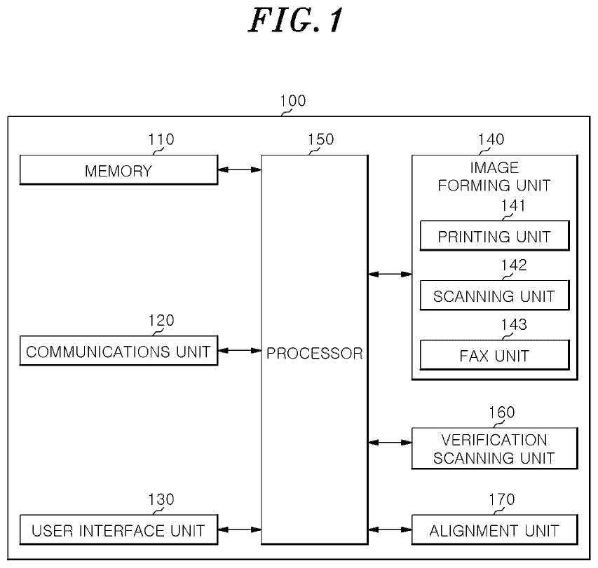

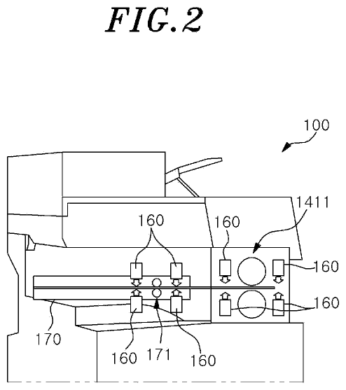

FIG. 1 is a block diagram illustrating an image forming apparatus according to an example. FIG. 2 is a diagram showing a candidate for an arrangement position of a verification scanning unit in an image forming apparatus according to an example.

Referring to FIGS. 1 and 2, an image forming apparatus 100 may comprise a memory 110, a communications unit 120, a user interface unit 130, an image forming unit 140, a processor 150, a verification scanning unit 160, and an alignment unit 170. It should be noted that the components of the image forming apparatus 100 are not limited to what is shown in FIG. 1. For example, the image forming apparatus 100 may further comprise a power supply for supplying power to each component, or other components, or at least one of the components depicted in FIG. 1 may be omitted in the image forming apparatus 100.

The image forming apparatus 100 may refer to one of individual devices, such as a printer, a scanner, a photocopier, a fax machine, and the like. Further, the image forming apparatus 100 may refer to an MFP in which functions of the individual devices are integrated into one device.

The image forming apparatus 100 may provide basic functions such as copying, printing, scanning, faxing, and the like. In addition, a separate application may be installed in the image forming apparatus 100. Through such an application, the image forming apparatus 100 may provide various additional functions.

Results provided by the image forming apparatus 100 may include printed materials or copies in which an image has been formed on a print medium such as paper.

However, such printed materials or copies may contain contamination that is unexpected by an operator For example, a streak may appear along a direction in which the print medium moves through the image forming apparatus 100, when a Laser Scanning Unit (LSU) beam scanning section is contaminated, when a roller used for fixing or discharging the print medium is contaminated, or due to other reasons.

Whether streaking occurs on the print medium may be checked through various example methods. In a first example method, a user or a manager of the image forming apparatus 100 may visually check whether a streak has been generated. In a second example method, a separate verification scanning unit may be provided in the image forming apparatus 100, so that it can be checked whether or not a streak has been generated by scanning an image formed on the print medium using the verification scanning unit and then examining the scanned image.

In the case of the second example method described above, when there is a defect in the verification scanning unit itself, for example, when the verification scanning unit is contaminated, the image scanned by the verification scanning unit may appear to contain a streak. In such an event, the user or the manager of the image forming apparatus 100, who would try to determine a cause of the streaking in the verification scanning unit, would not be able to find it, thereby incurring unnecessary time and costs.

Accordingly, in an example in which the image forming apparatus 100 employs a verification scanning unit, a technique is provided for determining whether a cause of streaking lies in the image forming unit or the verification scanning unit comprised in the image forming apparatus 100

To this end, in the image forming apparatus 100 according to an example, the verification scanning unit scans a first surface of a print medium on which no image has been formed, as well as a second surface of the print medium on which an image has been formed.

Hereinafter, example components of the image forming apparatus 100 will be described in more detail.

The memory 110 may be implemented by various storage media for storing data, such as a random access memory (RAM), a read only memory (ROM), or the like. Various types of information may be stored in the memory 110. For example, an instruction executable by the processor 150 may be stored in the memory 110. Further, various types of information obtained from an image which has been scanned and output by the verification scanning unit 160 may be stored in the memory 110, including information on a position of a streak, a coloring (e.g., darkness) of a streak, and the like.

The communications unit 120 is a component that enables the image forming apparatus 100 to communicate with each of various entities. The communications unit 120 may include various communications modules (e.g., transceivers). For example, the communications unit 120 may include a wireless communications module or a wired communications module. The communications unit 120 may include a variety of communications module, for example, a wired communications module and/or a wireless communications module. The wireless communications module may support Wireless Fidelity (Wi-Fi), Wi-Fi Direct, Bluetooth, Ultra-Wide Band (UWB), Long Term Evolution (LTE), Long Term Evolution-Advanced (LTE-A), Fifth Generation (5G), Near-Field Communication (NFC), or any other suitable type of wireless communication technologies, and the wired communications module may support Local Area Network (LAN), Universal Serial Bus (USB), High Definition Multimedia Interface (HDMI), or any other suitable type of wired communication technologies.

The user interface unit 130 may include an input unit and an output unit.

The input unit may receive various inputs from the user. For example, the user may select an image forming job to be carried out through the input unit. In addition, the user may select various options for the image forming job. For instance, the user may input a scan cycle to be applied to the verification scanning unit 160 as desired. In addition, by using the input unit, the user may select to execute the above-described application installed in the image forming apparatus. The input unit may include devices capable of receiving various types of user input, such as a keyboard, a keypad, a physical button, a touch pad, a touch screen, or the like.

Further, the output unit may display a result obtained by performing the image forming job, provide or output a state of the image forming apparatus 100 or a predetermined message, or the like. For example, the output unit may display a cause of streaking generated in the image forming apparatus 100. The output unit may include, e.g., a display panel, a speaker, or the like.

Each of the input unit and the output unit may comprise a variety of devices which support various types of inputs and/or outputs in addition to the above-described components.

The image forming unit 140 is may perform an image forming job, such as copying, printing, scanning, faxing, and the like. Although the image forming unit 140, as indicated in FIG. 1, may include a printing unit 141, a scanning unit 142, and a fax unit 143, it may include only some of these components or may include additional components for performing other types of image forming jobs as necessary.

Among the above components, the printing unit 141 may form an image on a print medium by adopting a printing mechanism including, but not limited to, an electro-photographic mechanism, an inkjet mechanism, a thermal transfer mechanism, a direct thermal mechanism, or the like. The printing unit 141 may include a fixing roller unit 1411 comprising a pair of rollers that rotate while the image is being fixed.

The scan unit 142 may irradiate light onto a document and receive light reflected therefrom to read imagery therefrom. In an example, an image sensor such as a charge coupled device (CCD) type sensor, a contact-type image sensor (CIS), or any other suitable type of image sensor may be used therein for the image reading from the document. In various examples, the scan unit 142 may have a flatbed structure in which an image sensor is to move to read an image from a document page placed fixedly on a specific location, a document feed structure in which document sheets are to be fed to allow a fixedly-positioned image sensor to read images therefrom, or a combination thereof.

The fax unit 143 may include a component to scan an image that may be shared by the scan unit 142, and a component to print a received image file that may be shared by the print unit 141. Further, the fax unit 143 may transfer a scanned image file to a destination or receive an image file from an external source.

The alignment unit 170 may align the print medium. For example, the alignment unit 170 may load one or more print media on which an image has been formed according to a corresponding order. Further, the alignment unit 170 may include a plurality of compartments so that a plurality of print media can be distinguished per user in case a plurality of users respectively output their own print medium. The alignment unit 170 may include an alignment roller unit (e.g., 171 of FIG. 2) comprising a pair of rollers used for discharging the print media.

The verification scanning unit 160 may be provided in the image forming apparatus 100 in addition to the scanning unit 142 and, like the scanning unit 142, may irradiate light onto a document and receive light reflected therefrom to read an image recorded in the document.

The verification scanning unit 160, when the result of the operation performed by the printing unit 141 or the scanning unit 142 has been printed on a print medium, may scan a first surface of the print medium and may scan a second surface of the print medium.

Hereinafter, various examples of a process in which the verification scanning unit 160 scans both surfaces of a print medium will be described.

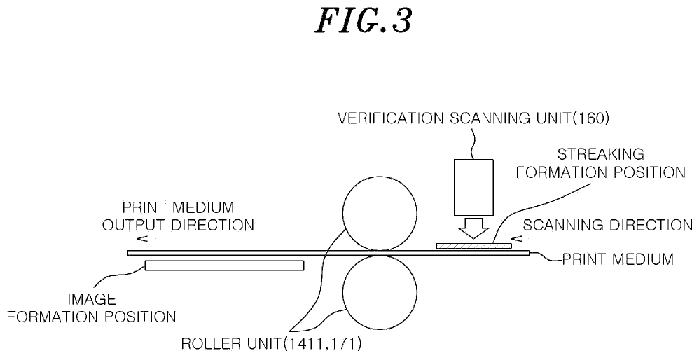

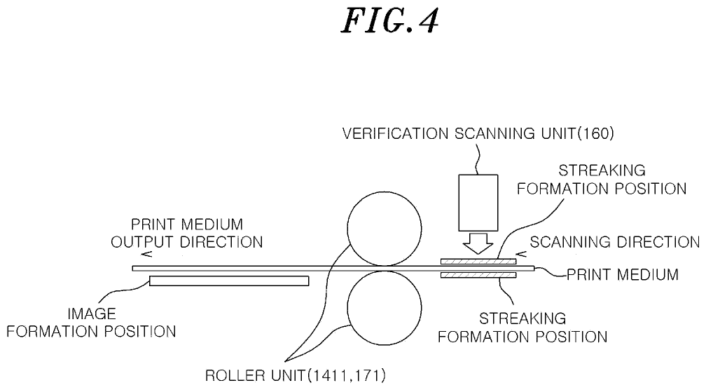

In an example, it is assumed that an image has been formed on a first surface of a print medium while no image has been formed on a second surface of the print medium, such print medium is output from the image forming apparatus 100, and the verification scanning unit 160 is arranged in the image forming apparatus 100 to face the second surface of the print medium so as to scan the second surface. In case that the image forming unit 140 flips the print medium in a double-sided printing mode such that the directions of the two surfaces are switched, the verification scanning unit 160 may also scan the first surface on which the image has been formed. This example will be described below in further detail with reference to FIGS. 3 and 4.

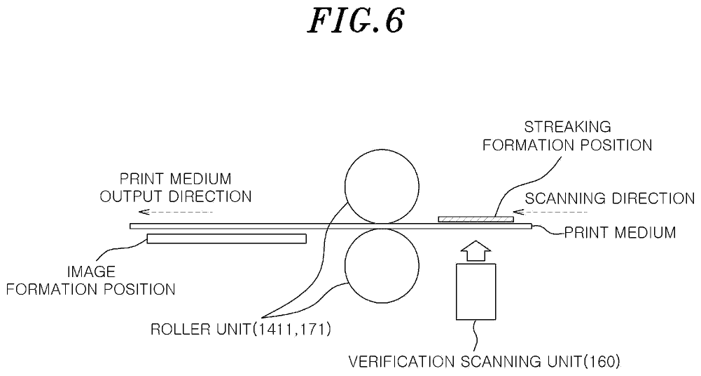

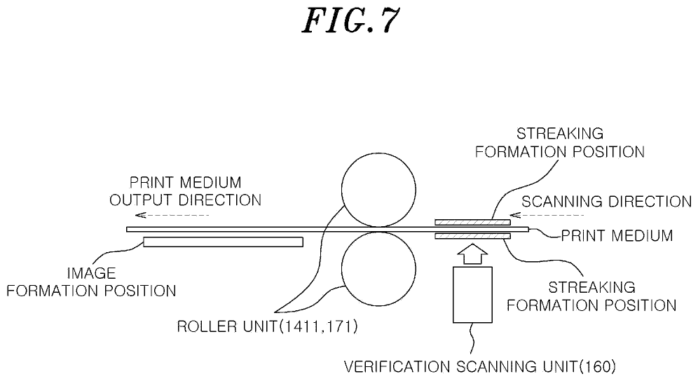

In another example, it is assumed that an image has been formed on a first surface of a print medium while no image has been formed on a second surface of the print medium, such print medium is output from the image forming apparatus 100, and the verification scanning unit 160 is arranged in the image forming apparatus 100 to face the first surface of the print medium so as to scan the first surface. In case that the image forming unit 140 flips the print medium in a double-sided printing mode such that the directions of the two surfaces are switched, the verification scanning unit 160 may also scan the second surface on which no image has been formed. Thereafter, if the image forming unit 140 forms an image on the first surface of the print medium in a one-sided printing mode, the verification scanning unit 160 may scan the first surface on which the image has been formed. This example will be described below in further detail with reference to FIGS. 6 and 7.

The verification scanning unit 160 may be disposed at various locations in the image forming apparatus 100. For example, it is assumed that there is a virtual line through which the print medium is output, and that the fixing roller unit 1411 and the alignment roller unit 171 are disposed on the virtual line. In that case, the verification scanning unit 160 may be disposed on the virtual line in front of or behind the alignment roller unit 171, or in front of or behind the fixing roller unit 1411, or between the fixing roller unit 1411 and the alignment roller unit 171, as presented in FIG. 2. The location where the verification scanning unit 160 is disposed may be chosen so that the highest flatness (i.e., maximum flatness) of the print medium on which the image has been formed can be achieved.

The processor 150 may execute an instruction stored in the memory 110. Further, the processor 150 may retrieve information stored in the memory 110. In addition, the processor 150 may store information in the memory 110 and may update the information already stored therein.

The processor 150 may include a component that controls an operation of the image forming apparatus 100 and may be implemented with a central processing unit (CPU), or the like. Hereinafter, example operations that may be executed by the processor 150 will be described

The processor 150 may determine whether there is a streak on an image scanned by the verification scanning unit 160. If it is determined that there is a streak, the processor may extract or obtain information on the position of the streak and information on the darkness of the streak. In this regard, techniques for determining whether there is a streak and extracting information on the position and darkness of the streak in case the streak exists by analyzing the scanned image are similar to well-known technologies for detecting a predetermined pattern from a photograph, and, thus, a detailed description thereof will be omitted.

The processor 150 may compare an image obtained by scanning the first surface of the print medium with the verification scanning unit 160 with an image obtained by scanning the second surface of the print medium with the verification scanning unit 160 to determine what causes a streak on the first surface or on the second surface. For example, if a streak is detected in the scanned image of the second surface of the print medium, the processor 150 determines that the streak has been caused by the verification scanning unit 160. If no streak is detected in the scanned image of the first surface of the print medium, the processor 150 determines that the image forming unit 140 has no cause of streaking and, thus, the cause of streaking lies solely in the verification scanning unit 160.

In contrast, if a streak is detected in the scanned image of the first surface of the print medium, as well as in the scanned image of the second surface of the print medium, the processor 150 may determine the cause of the streak on the first side of the print medium using one of the following examples.

If the position of the streak shown in the scanned image of the first surface does not match the position of the streak shown in the scanned image of the second surface, it is determined that the cause of the streak included in the first surface of the print medium lies in the image forming unit 140. In this case, it is determined that the cause of the streak included in the second surface of the print medium still lies in the verification scanning unit 160.

If the position of the streak shown in the scanned image of the first surface matches the position of the streak shown in the scanned image of the second surface, the processor 150 determines that the cause of the streak contained in the first surface of the print medium lies in the verification scanning unit 160. In addition, the information on the darkness of the streak contained in the first surface is compared with the information on the darkness of the streak contained in the second surface, and a comparison result is used for determining the cause of streaking. For example, even when the position of the streak contained in the scanned image of the first surface matches that of the second surface, such matching might be a coincidence that happens by chance if the difference in the darkness of the streaks is higher than or equal to a predetermined threshold. In such case, the processor 150 determines that the cause of the streak contained in the first surface of the print medium lies in the image forming unit 140. When the position of the streak contained in the scanned image of the first surface matches that of the second surface and the difference in the darkness of the streaks is less than the predetermined threshold, the processor 150 determines that the cause of the streak shown in the first surface of the print medium lies in the verification scanning unit 160.

If a streak is included in the scanned image of the first surface of the print medium while no streak is included in the scanned image of the second surface, the processor 150 determines that the cause of the streak on the first surface of the print medium lies in the image forming unit 140.

The processor 150 may also control the image forming unit 140 to operate in a single-sided printing mode or a double-sided printing mode. When the image forming unit 140 operates in the double-sided printing mode, unlike in the single-sided printing mode, the print medium is flipped over after an image has been formed on the first surface thereof, such that the directions of the two surfaces are switched.

Hereinafter, various examples will be described, including the above-described examples in which the verification scanning unit 160 scans each of the first surface and the second surface of the print medium.

FIGS. 3 and 4 are diagrams describing components of the image forming apparatus 100 employing the verification scanning unit 160 arranged in accordance with an example.

Referring to FIGS. 3 and 4, an image has been formed on a first surface of a print medium and no image has been formed on a second surface thereof. In the example of FIG. 3, streaking occurs only on the second surface. In the example of FIG. 4, streaking occurs on both of the first surface and the second surface. An example in which the streaking occurs only on the first surface will be described later.

In the examples of FIG. 3 and FIG. 4 in which the image has been formed only on the first surface of the print medium, the verification scanning unit 160 is disposed to face the second surface the print medium and scans the second surface of the print medium.

The processor 150 may control the first surface of the print medium to face the verification scanning unit 160 using a double-sided printing mode supported by the image forming unit 140. That is, in the double-sided printing mode, the print medium is flipped over. Then, the first surface of the print medium, on which the image has been formed, faces the verification scanning unit 160.

Hereinafter, an example procedure of determining a cause of streaking on a print medium will be described with reference to FIGS. 3 and 4.

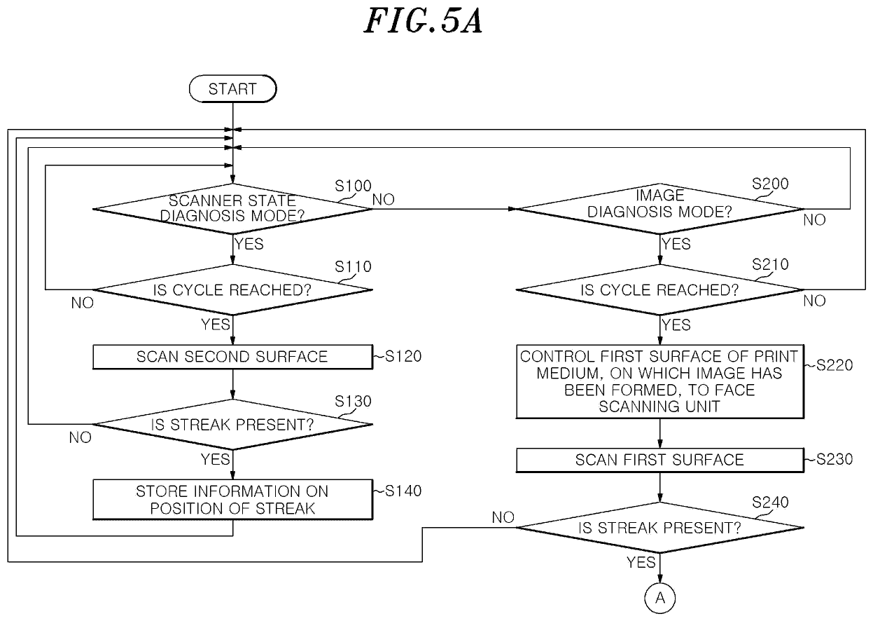

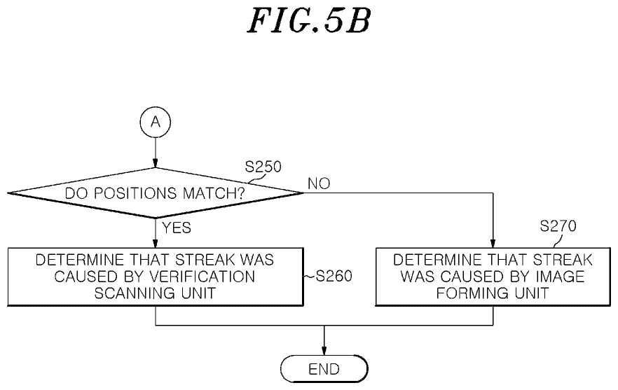

FIGS. 5A and 5B are flowcharts of a procedure for determining a cause of streaking in an image forming apparatus according to an example.

Referring to FIGS. 5A and 5B, the processor 150 determines whether the image forming apparatus 100 is in a scanner state diagnosis mode in operation S100. The image forming apparatus 100 may operate in the scanner state diagnosis mode when a predetermined condition is satisfied. For example, the image forming apparatus 100 may be driven to operate in the scanner state diagnosis mode when a predetermined time has elapsed after the image forming apparatus 100 started to operate, and the image forming apparatus 100 may be driven to operate in a normal operation mode prior to reaching the predetermined time.

If the result of the determination in operation S100 shows that the image forming apparatus 100 is in the scanner state diagnosis mode, it is determined whether or not a scanner state diagnosis cycle is reached in operation S110. The cycle may be reached, for example, when a predetermined number of copies (e.g., 5,000 copies) have been printed since the last scanner state diagnosis was performed. If the cycle is not reached, the procedure returns to operation S100, and if the cycle is reached, the verification scanning unit 160 scans a second surface of the print medium in operation S120.

In operation S130, it is determined if a streak is present on the second surface. If it is determined in operation S130 that there is no streak present on the second surface, the procedure returns to operation S100. On the other hand, if it is determined in operation S130 that there is a streak present on the second surface, the processor 150 obtains information on the position of the streak from the scanned image obtained in operation S120 and stores the information on the position of the streak in the memory 110 in operation S140. Since a streak is present at least on the second surface of the print medium in the examples of FIGS. 3 and 4, the processor 150 stores the information on the position of the streak in the memory 110. In this case, information on the darkness of the streak, although it is not described in the drawings, may also be obtained and stored in the memory 110.

After the information is stored in operation S140, the procedure returns to operation S100 to determine if the image forming apparatus 100 operates in the scanner state diagnosis mode. If it is determined in operation S100 that the image forming apparatus does not operate in the scanner state diagnosis mode, it is determined in operation S200 if the image forming apparatus 100 operates in the image diagnosis mode in operation S200. If it is determined in operation S200 that the image forming apparatus 100 does not operate in the image diagnosis mode, the procedure returns to operation S100. On the other hand, if it is determined in operation S200 that the image forming apparatus 100 operates in the image diagnosis mode, it is determined whether or not the image diagnosis cycle is reached in operation S210. The image diagnosis cycle may be reached, for example, when a predetermined number of copies (e.g., 2,000 copies) have been printed since the last image diagnosis was performed. When the cycle is not reached, the procedure returns to operation S100, and if the cycle is reached, the processor 150 controls the first surface of the print medium, on which the image has been formed, to face the verification scanning unit 160 using the double-sided printing mode of the image forming unit 140 in operation S220. Thereafter, the verification scanning unit 160 scans the first surface of the print medium in operation S230.

In operation S240, it is determined whether a streak is present as a result of the scanning in operation S230. If it is determined in operation S240 that there is no streaking present on the first surface, the procedure returns to operation S100, which corresponds to the example of FIG. 3. In this example, the processor 150 determines that the cause of streaking lies in the verification scanning unit 160.

On the other hand, if it is determined in operation S240 that a streak is present on the first surface, which corresponds to the example of FIG. 4, the processor 150 obtains information on the position of the streak from the scanned image obtained in operation S230, and compares the obtained position of this streak with the position of the streak stored in operation S140 to determine if the positions match in operation S250. If the result of the comparison in operation S250 indicates that the two positions match each other, the processor 150 determines that the streak in the scanned image of the first surface obtained in operation S230 was caused by the verification scanning unit 160 in operation S260. In contrast, if the result of the comparison in operation S250 indicates that the two positions do not match, the processor 150 determines that the streak in the scanned image of the first surface obtained in operation S230 was caused by the image forming unit 140 in operation S270.

In addition to the above, in operation S260, the information on the darkness of the streaks contained in the first surface may be compared with the information on the darkness of the streak contained in the second surface, so that the comparison result may be used for determining the cause of streaking. For example, even when the position of the streak contained in the scanned image of the first surface matches that of the second surface, such matching might be nothing more than a coincidence that happens by chance if the difference in the darkness of the two streaks is higher than or equal to a predetermined threshold. In other words, the image forming unit 140 generated the streak on the first surface of the print medium, the verification scanning unit 160 generated the streak on the second surface of the print medium, and the positions of the two streaks happen to be the same. Accordingly, the processor 150 determines that the cause of the streak on the first surface of the print medium is the image forming unit 140. When the position of the streak contained in the scanned image of the first surface matches that of the second surface and the difference in the darkness of the streaks is less than the predetermined threshold, the processor 150 determines that the cause of the streak shown on the first surface of the print medium lies in the verification scanning unit 160.

FIGS. 6 and 7 are diagrams depicting components of the image forming apparatus 100 employing the verification scanning unit 160 arranged according to an example.

Referring to FIGS. 6 and 7, an image has been formed on a first surface of a print medium while no image has been formed on a second surface of the print medium. In the example of FIG. 6, streaking occurs only on the second surface. On the other hand, in FIG. 7, streaking occurs on both of the first surface and the second surface. The example in which the streaking occurs only on the first surface will be described later

In the examples of FIGS. 6 and 7 in which the image has been formed only on the first surface of the print medium, the verification scanning unit 160 is disposed to face the first surface of the print medium and scans the first surface of the print medium.

In addition, the processor 150 controls the second surface of the print medium to face the verification scanning unit 160 using a double-sided printing mode supported by the image forming unit 140. Then, the verification scanning unit 160 may scan the second surface of the print medium.

After the second surface of the print medium is scanned, the image forming unit 140 forms an image on a first surface of another print medium. In this case, the image forming unit 140 operates in the single-sided printing mode.

Thereafter, the verification scanning unit 160 scans the first surface of said another print medium on which the image has been formed in the single-sided printing mode. It should be noted that the image has been formed on the first surface of said another print medium.

Hereinafter, with regard to the examples of FIGS. 6 and 7, an example procedure of determining a cause of streaking on the print medium will be discussed.

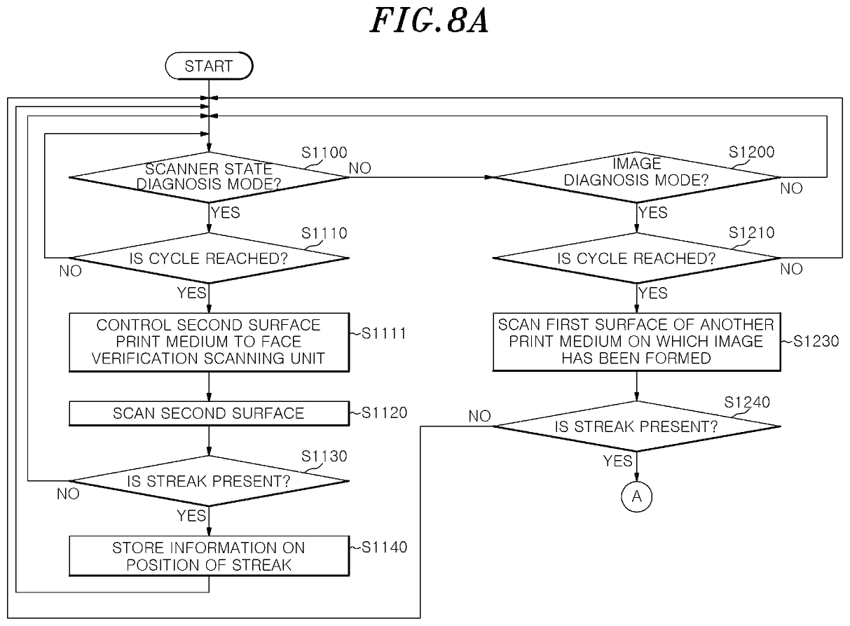

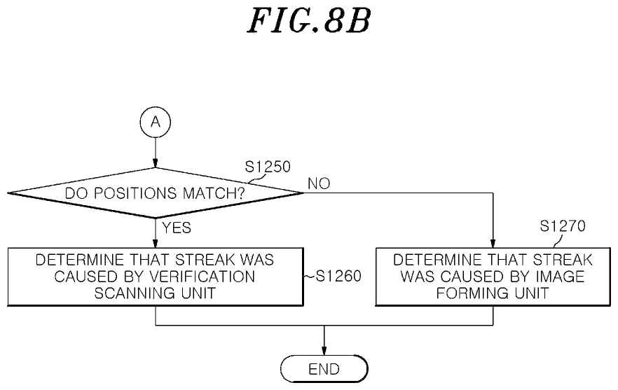

FIGS. 8A and 8B are flowcharts of a procedure for determining a cause of streaking in an image forming apparatus according to an example.

Referring to FIGS. 8A and 8B, the processor 150 determines whether the image forming apparatus 100 is in a scanner state diagnosis mode in operation S1100. The scanner state diagnosis mode here is the same as that in the example of FIGS. 5A and 5B.

If the result of the determination in operation S1100 shows that the image forming apparatus 100 is in the scanner state diagnosis mode, it is determined whether or not a scanner state diagnosis cycle is reached in operation S1110. The cycle may be reached, for example, when a predetermined number of copies (e.g., 5,000 copies) have been printed since the last scanner state diagnosis was performed. If the cycle is not reached, the procedure returns to operation S1100, and if the cycle is reached, the processor 150 controls the second surface of the print medium, on which no image has been formed, to face the verification scanning unit 160 using the double-sided printing mode of the image forming unit 140 in operation S1111. The verification scanning unit 160 scans the second surface of the print medium in operation S1120.

In operation S1130, it is determined if a streak is present on the second surface. If it is determined in operation S1130 that there is no streak present on the second surface, the procedure returns to operation S1100. On the other hand, if it is determined in operation S1130 there is a streak present on the second surface, the processor 150 obtains information on the position of the streak from the scanned image of the second surface obtained in operation S1120 and stores the information on the position of the streak in the memory 110 in operation S1140. Since a streak is present at least on the second surface of the print medium in the examples of FIGS. 6 and 7, the processor 150 stores the information on the position of the streak in the memory 110. In this case, information on the darkness of the streak, although it is not described in the drawings, may also be obtained and stored in the memory 110.

After the information is stored in operation S1140, the procedure returns to operation S1100 to determine if the image forming apparatus 100 operates in the scanner state diagnosis mode. If it is determined in operation S1100 that the image forming apparatus does not operate in the scanner state diagnosis mode, it is determined if the image forming apparatus 100 operates in the image diagnosis mode in operation S1200. If it is determined in operation S1200 that the image forming apparatus 100 does not operate in the image diagnosis mode, the procedure returns to operation S1100. On the other hand, if it is determined in operation S1200 that the image forming apparatus 100 operates in the image diagnosis mode, it is determined whether or not the image diagnosis cycle is reached in operation S1210. The cycle may be reached, for example, when a predetermined number of copies (e.g., 2,000 copies) have been printed since the last image diagnosis was performed. If the cycle is not reached, the procedure returns to operation S1100, and if the cycle is reached, the verification scanning unit 160 scans a first surface of another print medium on which an image has already been formed in operation S1230. Here, “another print medium on which an image has already been formed” refers to a print medium that has been processed by the image forming unit 140 after the second surface of the previous print medium was scanned at steps S1111 to S1140.

In operation S1240, it is determined whether a streak is present as a result of the scanning in operation S1230. If it is determined in operation S1240 that there is no streak present on the first surface of the other print medium, which corresponds to the example of FIG. 6, the procedure returns to operation S1100. In this example, the processor 150 determines that the cause of streaking lies in the verification scanning unit 160.

On the other hand, if it is determined in operation S1240 that a streak is present on the first surface of the other print medium, which corresponds to the example of FIG. 7, the processor 150 obtains information on the position of the streak from the scanned image of the first surface obtained in operation S1230, and compares the obtained position of this streak with the position of the streak stored in operation S1140 to determine if the positions match in operation S1250. If the result of the comparison in operation S1250 indicates that the two positions match each other, the processor 150 determines that the streak in the scanned image of the first surface obtained in operation S1230 was caused by the verification scanning unit 160 in operation S1260. In contrast, if the result of the comparison in operation S1250 shows that the two positions do not match, the processor 150 determines that the streak in the scanned image of the first surface obtained in operation S1230 was caused by the image forming unit 140 in operation S1270.

In addition to the above, in operation S1260, the information on the darkness of the streak contained in the first surface may be compared with the information on the darkness of the streak contained in the second surface, so that the comparison result may be used for determining the cause of streaking, as explained above with regard to the first example.

As discussed above, according to an example, the cause of streaking in the image forming apparatus employing the verification scanning unit can be accurately determined. Therefore, the manager of the image forming apparatus 100 will be able to take appropriate measures for the image forming apparatus depending on the cause of streaking.

The examples of FIGS. 3, 4, 6, and 7 do not encompass a case in which there is no streak present on the second surface of the print medium while a streak is present on the first surface thereof. In an example where a streak is present only on the first surface of the print medium, however, no streak will be detected in an image obtained by scanning the second surface of that print medium. Even in such case as no streak is detected in the scanned image of the second surface of the print medium, the processor 150 may determine whether there is a streak present in a scanned image of the first surface of that print medium once a predetermined cycle is reached. If a streak is detected in the scanned image of the first surface, the processor 150 determines that the cause of the streak on the first surface lies in the image forming unit 140.

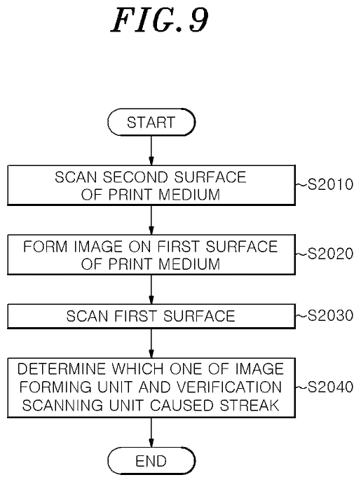

FIG. 9 is a flowchart of a procedure of an image forming method according to an example.

In the following example, the image forming method illustrated in FIG. 9 is performed by the image forming apparatus 100 represented in FIG. 1 for ease of description.

Referring to FIG. 9, a second surface of a print medium on which no image has been formed is scanned in operation S2010.

In operation S2020, an image is formed on a first surface of the print medium.

In operation S2030, the first surface of the print medium is scanned.

In operation S2040, it is determined which one of the image forming unit and the verification scanning unit included in the image forming apparatus caused streaking on each of the first surface and the second surface is performed, based on information on the position of a streak shown in the scanned images of the first surface and that of the second surface.

Since the above image forming method is performed by the image forming apparatus 100 described above, the description of the image forming apparatus 100 can be applied to the image forming method as well.

Each of the operations included in the above-described example image forming method may be implemented through a computer program configured to perform those operations, and the computer program may be stored in a non-transitory computer-readable recording medium and executed by a processor.

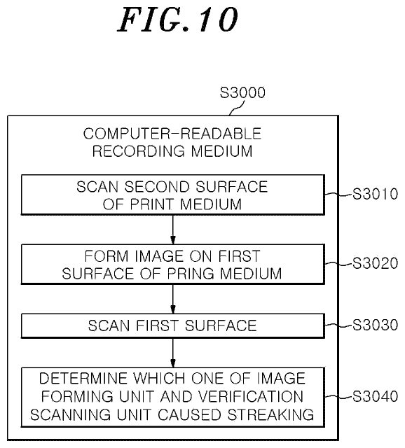

FIG. 10 illustrates a computer-readable recording medium according to an example.

Referring to FIG. 10, a computer-readable recording medium 3000 may have instructions stored thereon. For example, the computer-readable recording medium 3000 may include instructions S3010 for scanning a second surface of a print medium, on which no image has been formed.

The computer-readable recording medium 3000 may include instructions S3020 for forming an image on a first surface of the print medium.

The computer-readable recording medium 3000 may include instructions S3030 for scanning the first surface.

The computer-readable recording medium 3000 may include instructions S3040 for determining which one of an image forming unit and a verification scanning unit included in the image forming apparatus caused streaking on each of the first surface and the second surface is performed, based on information on the position of a streak shown in the scanned images of the first surface and the second surface.

In an example, the instructions illustrated in the flowchart may be performed by the image forming apparatus 100 described above.

The computer readable storage medium 3000 may be a non-transitory computer readable medium. The term “non-transitory computer readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USE, a memory card, a ROM device, or any of other types of non-transitory readable media.

In an example, the methodology disclosed herein may be incorporated into a computer program product. The computer program product may be available as a product for trading between a seller and a buyer. The computer program product may be distributed in the form of a machine-readable storage medium, e.g., compact disc read only memory (CD-ROM), or distributed online through an application store, e.g., PlayStore™. For online distribution, at least a portion of the computer program product may be temporarily stored, or temporarily created, in a storage medium such as a server of the manufacturer, a server of the application store, or a storage medium such as a memory of a relay server.

The foregoing description has been presented to illustrate and describe various examples. It should be appreciated by those skilled in the art that modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. An image forming apparatus comprising:
an image forming unit to form an image on a print medium;
a verification scanning unit to scan a first surface of the print medium on which an image has been formed and to scan a second surface of the print medium on which no image has been formed; and
a processor to determine, based on information on a position of a streak included in a scanned image of the first surface or the second surface, whether the streak has been caused by the image forming unit or the verification scanning unit.

2. The image forming apparatus of claim 1, wherein, when the streak is included in the scanned image of the second surface, the processor is to determine that the streak was caused by the verification scanning unit.

3. The image forming apparatus of claim 2,
wherein the streak is included in the scanned image of the first surface and the scanned image of the second surface, and
wherein the processor is to:
determine that the streak included in the scanned image of the first surface was caused by the verification scanning unit if the position of the streak shown in the scanned image of the first surface matches the position of the streak shown in the scanned image of the second surface, and
determine that the streak included in the scanned image of the first surface was caused by the image forming unit if the position of the streak shown in the scanned image of the first surface does not match the position of the streak shown in the scanned image of the second surface.

4. The image forming apparatus of claim 3, wherein information on a darkness of the streak included in the scanned image of each of the first surface and the second surface is obtained, and
wherein, when the position of the streak included in the scanned image of the first surface matches the position of the streak included in the scanned image of the second surface, the processor is to determine that the streak included in the scanned image of the first surface was caused by the verification scanning unit if a difference in the information on the darkness of the streak obtained from the scanned images is less than a predetermined threshold, and is to determine that the streak included in the scanned image of the first surface was caused by the image forming unit if said difference is greater than or equal to the predetermined threshold.

5. The image forming apparatus of claim 1,
wherein the verification scanning unit is disposed to face the second surface of the print medium so as to scan the second surface when the print medium, on which the image has been formed, is output,
wherein the processor is to control the first surface of the print medium to face the verification scanning unit using a double-sided printing mode of the image forming unit, and
wherein the verification scanning unit is to scan the first surface facing the verification scanning unit.

6. The image forming apparatus of claim 1,
wherein the verification scanning unit is disposed to face the first surface of the print medium when the print medium, on which the image has been formed, is output,
wherein the processor is to control the second surface of the print medium to face the verification scanning unit using a double-sided printing mode of the image forming unit,
wherein the verification scanning unit is to scan the second surface facing the verification scanning unit,
wherein the image forming unit is to form another image on a first surface of another print medium in a single-sided printing mode, and
wherein the verification scanning unit is to scan the first surface of the other print medium on which the other image has been formed in the single-sided printing mode.

7. The image forming apparatus of claim 1, wherein the verification scanning unit is disposed on a line through which the print medium is output to obtain a maximum flatness of the print medium.

8. The image forming apparatus of claim 1,
wherein the image forming unit includes a fixing roller unit, disposed on a line through which the print medium is output, to rotate to fix the image, and
wherein the verification scanning unit is disposed in front of or behind the fixing roller unit on the line.

9. The image forming apparatus of claim 8, further comprising an alignment roller unit, disposed on the line, to align the print medium on which the image has been formed,
wherein the verification scanning unit is disposed between the fixing roller unit and the alignment roller unit on the line.

10. The image forming apparatus of claim 1, further comprising an alignment roller unit, to align the print medium on which the image has been formed, disposed on a line through which the print medium is output,
wherein the verification scanning unit is disposed in front of or behind the alignment roller unit on the line.

11. An image forming method performed by an image forming apparatus, the method comprising:
scanning a second surface of a print medium on which no image has been formed;
forming an image on a first surface of the print medium;
scanning the first surface; and
determining, based on information on a position of a streak included in a scanned image of the first surface or the second surface, whether the streak has been caused by an image forming unit or a verification scanning unit of the image forming device.

12. The method of claim 11, wherein, when the streak is included in the scanned image of the second surface, the determining comprises determining that the streak included in the scanned image of the second surface was caused by the verification scanning unit.

13. The method of claim 12,
wherein the streaking is included in the scanned image of the first surface and the scanned image of the second surface, and
wherein the determining comprises:
determining that the streak included in the scanned image of the first surface was caused by the verification scanning unit if the position of the streak shown in the scanned image of the first surface matches the position of the streak shown in the scanned image of the second surface, and
determining that the streak included in the scanned image of the first surface was caused by the image forming unit if the position of the streak shown in the scanned image of the first surface does not match the position of the streak shown in the scanned image of the second surface.

14. The method of claim 13, further comprising obtaining information on a darkness of the streak included in the scanned image of each of the first surface and the second surface,
wherein, when the position of the streak included in the scanned image of the first surface matches the position of the streak included in the scanned image of the second surface, the determining comprises:
determining that the streak included in the scanned image of the first surface was caused by the verification scanning unit if a difference in the information on the darkness of the streak obtained from the scanned images is less than a predetermined threshold, and
determining that the streak included in the scanned image of the first surface was caused by the image forming unit if said difference is greater than or equal to the predetermined threshold.

15. A computer-readable recording medium storing a computer program performed by an image forming apparatus, the computer-readable recording medium comprising:
instructions to control a second surface of a print medium, on which no image has been formed, to be scanned;
instructions to control an image to be formed on a first surface of the print medium;
instructions to control the first surface to be scanned; and
instructions to determine, based on information on a position of a streak included in a scanned image of the first surface or the second surface, whether the streak has been caused by an image forming unit or a verification scanning unit of the image forming apparatus.
